(19) United States
(12) Patent Application Publication
(10) Pub. No.: US 2002/0135230 A1
(43) Pub. Date: Sep. 26, 2002

(54) Vehicle safety feature

(76) Inventor: John R. Curtin JR., Stephens City, VA (US)

Correspondence Address: Richard C. Litman, LITMAN LAW OFFICES, LTD., P.O. Box 15035, Arlington, VA, 22215, US

(21) Appl. No.: 09/813,783

(22) Filed: Mar. 22, 2001

(51) Int. Cl. B60R 21/01

(52) U.S. Cl. 307/10.1

(57) ABSTRACT

A vehicle safety feature having a single button or switch in the operator area that can deactivate sound producing vehicle accessories, such as defrosters, heaters, radios, etc., allowing drivers of school buses and other large, hazardous material carrying or passenger carrying vehicles to eliminate noise when approaching railroad crossings, thus assisting in the detection of approaching train whistles or horns. The device may assist in hearing emergency vehicles in the area. The switch may be flip-flop, spring-loaded, instantaneous, or timed so that it resets when a set time expires. The switch may be color coded or lighted. The switch may activate a prerecorded message to advise passengers. The present invention may be adapted for use in any transportation vehicle including aircraft, trains and boats.

### BACKGROUND OF THE INVENTION

1. Field of the Invention

The present invention relates to transportation vehicles. More particularly, the present invention relates to safety features for a transportation vehicle which turn off noise-making accessories to enhance the ability of the operator to hear audible warning whistles, emergency sirens, etc.

2. Description of the Related Art

The tragedy of a school bus being hit by a train at a track crossing occurs too often and seems just around the corner. Increasing traffic congestion in suburbs exacerbates the problem. It would be helpful to provide the school bus operator with a simply installed and maintained system which would allow the driver to turn off noise making accessories when approaching a train track crossing. This would allow the driver to more readily hear a train whistle or horn, or the train, itself, thus enhancing the safety of the crossing. It would also be useful if that system could easily be manually or automatically activated to return all accessories to an operational state once the bus is out of harm's way. Such a device would also be useful when an emergency vehicle is spotted or faintly heard. Many times when one emergency vehicle is discovered, another is nearby and this system would be useful in hearing the second vehicle siren. The system would preferably be adaptable to other transportation systems such as large trucks, and airplanes.

U.S. Pat. No. 4,238,778, issued Dec. 9, 1980, to Ohsumi describes a system for warning of the approach of an emergency vehicle, comprising a transmitter on an emergency vehicle, such as a police car, an ambulance, etc., and a receiver on the user's vehicle. The signal receiver in the user's vehicle includes means for disabling selected sound-producing devices, such as the radio, ventilation fans, etc. in response to the radio frequency warning signal. The '778 system is dependent upon both vehicles having compatible and operable devices, and the system is inherently complicated and subject to interference.

U.S. Pat. No. 5,554,982, issued Sep. 10, 1996, to Shirkey et al. describes a wireless train proximity alert that includes a transmitter on the train and a vehicle-installed proximity alert system, which includes an RF receiver, a GPS receiver, a controller, a transponder, and alarms. The '982 system is dependant upon an number of elements to be present and in working condition, and is also complicated and subject to RF interference.

U.S. Pat. No. 4,794,394, issued Dec. 27, 1988, to Halstead describes an emergency vehicle proximity warning system that disconnects the car radio speakers from the radio receiver so that a separate audio/visual warning device within the passenger compartment will be heard and/or seen by the vehicle driver. The '394 system is not within the direct control of the driver, and may be subject to false activations, resulting in a nuisance or even safety compromise.

U.S. Pat. No. 5,555,502, issued Sep. 10, 1996 to Opel describes a control system for a vehicle wherein the electronic components are controlled from a single control panel on the steering wheel. In the '502 system, no provision is made to control a set of noise emanating accessories with a single switch.

U.S. Pat. No. 3,876,940, issued Apr. 8, 1975, to Wickord et al. describes a driver's safety warning system that emits an emergency vehicle warning directly through the passengers' vehicle radio by muting the radio broadcast. The system broadcasts the message even in cases where the radio is turned off. Again, the '940 system requires two operable and compatible units, and is subject to RF interference.

U.S. Pat. No. 5,401,924, issued Mar. 28, 1995, to Armanno, Sr. describes a remote battery switch that allows the user to remotely disconnect and connect the vehicle's electrical system. Although the '924 is a valuable invention when employed in the context of its intended use, it would be impractical in the scenario presented above.

U.S. Pat. No. 4,691,116, issued Sep. 1, 1987, to Kiyono et al. describes a switch control device for a vehicle. The device controls one set of accessories when an engine is running, and another set of accessories when the engine is not running. The sets of accessories may overlap. The '116 system is not tailored to controlling noise emitting accessories, and is tied to engine operation rather than being activated by the driver.

U.S. Pat. No. 4,578,592, issued Mar. 25, 1986, to Nakazawa et al. describes a steering-wheel mounted accessory control system. As described in FIG. 4a, the number of switches may be used to control are fewer than the number of accessories controlled. The '592 embodiments to not appear to provide for switching on or off a set of accessories, i.e., noise emitting accessories, with the single activation of a switch.

U.S. Pat. No. 4,276,483, issued Jun. 30, 1981, to Hayden describes a timed or delay electric switch for vehicle accessories. Although possibly useful in the present invention, the '483 device fails to provide a complete system which is capable of alleviating the danger of the scenario presented above.

None of the above inventions and patents, taken either singularly or in combination, is seen to describe the instant invention as claimed. Thus, a vehicle safety feature solving the aforementioned problems is desired.

### SUMMARY OF THE INVENTION

The present invention is a vehicle safety feature or device comprising a single button or switch in the operator area that can deactivate predetermined vehicle accessories, particularly those which produce sounds, such as defrosters, heaters, radios, etc. The purpose of the device is to allow drivers of school busses, hazardous materials carrying trucks and tractor trailers, other passenger vehicles, or large vehicles to eliminate as much peripheral or unnecessary noise as possible when approaching or stopped at railroad crossings so that the vehicle operator can hear as clearly as possible. The device may also be used to hear emergency vehicles when not at a railroad crossing. The switch may be spring-loaded so that it resets when the driver releases the switch, or it may be timed so that it resets when a set time expires. The switch may be color coded by coloring the switch itself or a lighted portion of the switch and/or a unique shape for easier user identification. The switch may be lit upon activating vehicle headlights. The switch may also activate a prerecorded message to advise passengers. The present invention may be adapted for use in any transportation vehicle including aircraft, trains and boats.

Accordingly, it is a principal object of the invention to provide a system to render a vehicle relatively quiet when approaching a train track crossing or when an emergency vehicle is detected by a vehicle operator as compared to normal noise levels within the vehicle.

It is another object of the invention to provide a switch for a vehicle electrical system which is capable of suspending the operation of any set of preselected accessories, particularly those which emit noise.

It is a further object of the invention to provide the operator with a choice of instantaneous, continuous, or automatic time delayed reactivation of accessories, once the system is activated.

Still another object of the invention is to provide a system as above which has a time delay on the switch sufficient to maintain silence over a multi-track crossing.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is a block diagram illustrating the combination of components of a vehicle safety feature according to the present invention.

FIG. 2 is an illustration of an electrical circuit useful in accomplishing the operation of the present invention.

FIG. 3 in an illustration as in FIG. 2 employing a remote-control device and responsive switch.

Similar reference characters denote corresponding features consistently throughout the attached drawings.

### DETAILED DESCRIPTION OF THE PREFERRED EMBODIMENTS

The present invention is a vehicle safety feature comprising a single button or switch in the operator area that can deactivate preselected vehicle accessories, particularly those which produce sounds, such as defrosters, heaters, radios, etc. The purpose of the device is to allow drivers of school buses, hazardous material carriers, tractor trailers, other passenger vehicles, or other large vehicles to eliminate as much peripheral or unnecessary noise as possible when approaching or stopped at railroad crossings so that the vehicle operator can hear as clearly as possible. The device may also be used to hear emergency vehicles when not at a railroad crossing. The switch may be spring-loaded so that it resets when the driver releases the switch, or it may be timed so that it resets when a set time expires. The switch may be color coded by coloring the switch itself or a lighted portion of the switch for easier user identification. The switch may be illuminated along with the headlights to aid it being seen at night. The switch may also activate a prerecorded message and cabin mounted emergency lights and/or short duration warning sound to advise passengers. The present invention may be adapted for use in any transportation vehicle including aircraft, trains and boats.

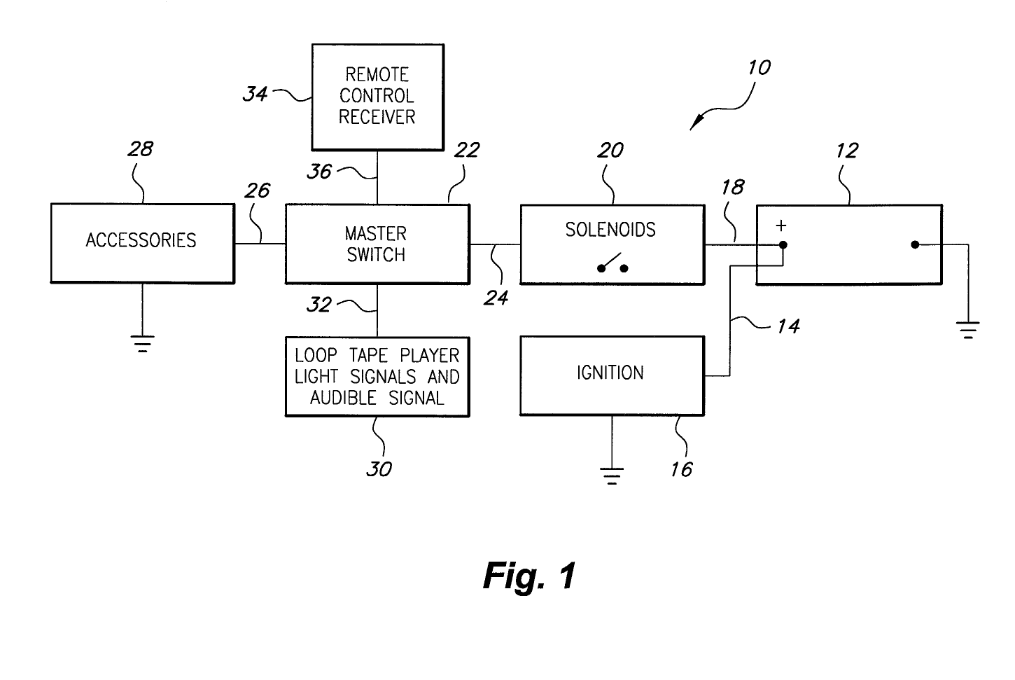

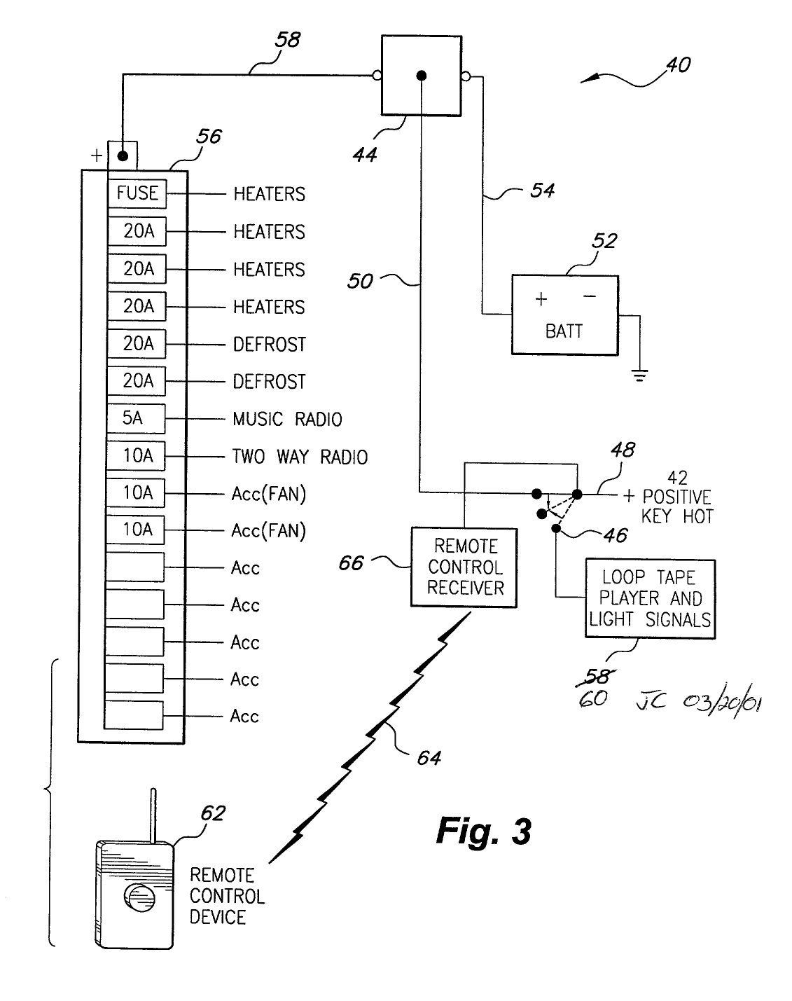

Referring to FIG. 1, there is shown a block diagram of the present inventive vehicle safety system 10. As shown, battery 12 provides parallel connections, i.e., first parallel electrical conduit 14 to ignition 16, and second parallel electrical conduit 18 to any solenoids or relays 20 activated through electrical input conduit 24 by master switch 22 of the invention. Master switch 22 provides electrical power through a circuit protector(not shown) such as a fuse box, a circuit board, or the equivalent to a preselected group of accessories 28 which produce noise in the vehicle cabin by means of master switch electrical output conduit 26. Upon activation of master switch 22, electrical power is interrupted to the solenoids or relays 20 and the circuit protector, and, thus, the group of accessories 26 are de-energized, providing a quiet cabin. The switch may also provide an electrical conduit 32 controlling a solenoid(not shown) to activate a loop tape player 30, or equivalent device, to provide any desired audible and/or visual signal inside the vehicle in a known manner(not shown). Master switch 22 may also be remotely controlled by remote control receiver 34 by means of remote control electrical conduit 36 and activated by a hand-held remote control(see FIG. 3) carried by a responsible person in charge of the group. Master switch 22 may be an instantaneous switch which must be held in for deactivation of the accessories, a flip-flop switch which must be separately activated and deactivated, a time delay switch which activates the switch for a preset time, e.g., the time it takes for the vehicle to cross railroad tracks and hear the taped warning, or a multi contact switch which can combine the operating characteristics of each of the previously describes switches.

In one embodiment of the multi contact switch, a three-position switch in the off position will be normally closed, allowing power to all accessories. A second position is the on position, opening the circuit to all noise making accessories. A third position is a momentary position which enables the system to emit a quick sound, activate a recorded message, flash the dome lights and/or activate signs to notify passengers to be quiet. The switch automatically returns to the on position after the vehicle operator releases any pressure on the switch, thus keeping accessories off until the driver runs the switch to the off position. This is a type of switch configuration similar to a vehicle ignition switch. The three-way switch may have a time delay automatically deactivating the switch upon passage of a pre-selected time. A lighted portion of the activated switch may be in a flashing mode, notifying the operator that the switch remains on. The switch may be lighted and/or color coded and/or have a unique shape to assist in location of the switch, and separately lighted to indicate the switch is activated. Such switches are well known in the electrical arts, the details of which form no part of the present invention.

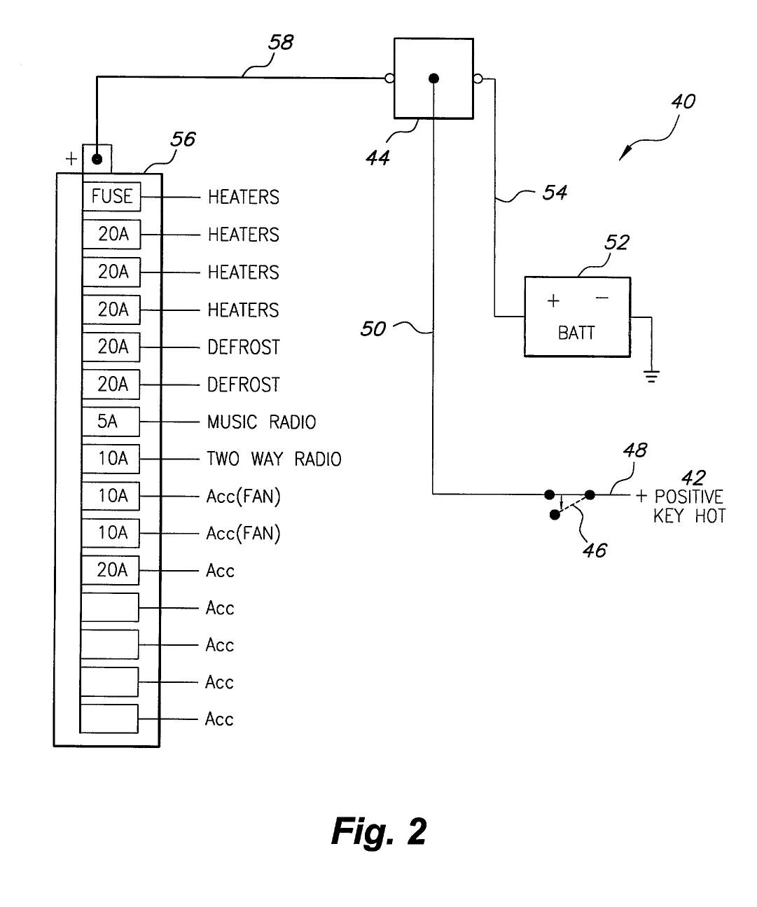

FIG. 2 shows an electrical circuit 40 illustrating an alternative embodiment of the inventive vehicle safety system 10(see FIG. 1), where vehicle key ignition switch 42, connected to a source of electrical power (not shown), activates solenoid or relay 44 by means of master switch 46 through electrical conduits 48 and 50, respectively, thereby connecting battery 52 by means of electrical conduit 54 and 58, respectively, to pre-selected accessory group circuit protector or fuse box 56. The pre-selected accessory group includes noise emitting accessories. Upon activation of the master switch 46(opening the circuit), the solenoid or relay 44 disconnects electrical power to selected accessory group circuit protector or fuse box 56 thus leaving the cabin relatively quiet. Upon deactivation of the master switch 46, the accessories are reactivated.

FIG. 3 shows an electrical circuit 40 similar to that of FIG. 2 wherein the master switch 46 may be activated and de-activated by the operator or by employing hand-held remote control 62 by means of Rf signal 64 through remote control receiver 66. Master switch 46 is illustrated in three-position form which preferably has (1) a closed default position actuating solenoid or relay 44 connecting battery 52 with the selected group of accessories served by circuit protector or fuse box 56, (2) an open position which inactivates solenoid or relay 44 and thereby the selected group of accessories served by circuit protector or fuse box 56, and which may be either a flip-flop connection or a timed connection returning to the closed default position, and (3) an instantaneous position which sends a signal activating a loop tape message player and cabin interior warning lights and/or a brief audible signal 58.

In operation, the vehicle ignition key is turned on and the vehicle driven until reaching a railroad crossing. At this point the master switch (22,46) is activated. If the switch is an instantaneous type, the operator presses the switch to listen for oncoming trains. This may be done upon the opening of the passenger door as is customary for buses. The master switch may then be allowed to disengage, while the bus crosses the tracks. If the switch is time delayed, a preset time passes, adequate for the operator to stop, open the bus door, and listen for oncoming trains. If the master switch is a straight flip-flop switch, the operator activates the switch upon approach to a railroad crossing, and then deactivates the switch after crossing. If the master switch is a combination switch, such as a three-position switch, the operator may manipulate the switch to choose the operating mode desired.

In a preferred mode, a three-position switch is employed, where the off position will be normally closed, allowing delivery of electrical power to all accessories. A second position is the on position, opening the circuit to all noise making accessories. A third position is a momentary position which enables the system to emit a sharp brief sound, activate a recorded message, flash the dome lights or activate signs to notify passengers to be quiet as desired. The switch automatically returns to the on position after the vehicle operator releases pressure on the switch, thus keeping accessories off until the driver turns the switch to the off position. This switch may have a time delay which energizes a lighted portion of the switch in a flashing mode, notifying the operator that the switch remains on. This is a preferred mode in that it allows the operator to maintain silence until all the tracks are crossed, while minimizing the elapse of time during which the accessories are off.

In the case that the switch is used to assist in hearing nearby emergency vehicle sirens and horns, a flip-flop mode would be preferable. A switch override(not shown) may provide power to essential accessories, such as windshield wipers, when the operator deems it necessary.

The inventive system may be constructed of elements known in the vehicle electrical systems arts. and need no further description, nor are they individually part of the present inventive combination of elements. A separate circuit protector or fuse box may be employed for noisy accessories, or a universal type circuit protector or fuse box may be adapted to operate within the context of the present invention. Alternatively, the master switch may control separate solenoids or relays directing electrical power to each noise-making accessory, thus making the system more easily adaptable to existing weather conditions or driver preferences.

It is to be understood that the present invention is not limited to the embodiments described above, but encompasses any and all embodiments within the scope of the following claims.

I claim:

1. A vehicle safety feature or device comprising:
a) a source of electrical power;
b) a master switch connected with said source of electrical power; and
c) a circuit protector so configured that said master switch is operable to deactivate a selected group of electrical accessories which emit noise during operation, thereby providing for a relatively quiet vehicle cabin.

2. The vehicle safety feature of claim 1, said source of electrical power being a standard vehicle battery, said fuse box being connected by at least one solenoid or relay to said battery said solenoid or relay being operable by an ignition switch, said master switch being electrically located between said at least one solenoid or relay and said fuse box.

3. The vehicle safety feature of claim 1, said source of electrical power being a standard vehicle battery, said circuit protector fuse box being connected by a solenoid or relay to said battery, and said master switch being electrically connected to a source of electrical power and controlling said solenoid or relay.

4. The safety feature of claim 2, wherein said solenoid or relay is in an activated state, allowing electrical connection of said circuit protector and said battery, when said master switch is in an inactivated state.

5. The vehicle safety feature of claim 4, wherein said master switch is an instantaneous switch capable of remaining in an activated state by continuous pressure thereon by the vehicle operator.

6. The vehicle safety feature of claim 4, wherein said master switch is a flip-flop switch capable of remaining in an activated state until deactivation by a vehicle operator.

7. The vehicle safety feature of claim 4, wherein said master switch is a time delay switch capable of remaining activated over a pre-set time period.

8. The vehicle safety feature of claim 4, wherein said master switch is a combination switch providing for at least two of instantaneous activation, flip-flop activation, and time-delay activation by selected manipulation of said switch by the vehicle operator.

9. The vehicle feature of claim 2, wherein said master switch further comprises remote control means for selective activation.

10. The safety feature of claim 2, wherein said master switch is at least one of color coded or uniquely shaped for easy identification.

11. The safety feature of claim 2, wherein said master switch comprises means for lighting said master switch indicating at least one of an inactivated state, an activated state, and a differentiated inactivated and activated state.

12. The safety feature of claim 3, wherein said solenoid or relay is in an activated state, allowing electrical connection of said circuit protector and said battery, when said master switch is in an inactivated state.

13. The vehicle safety feature of claim 12, wherein said master switch is an instantaneous switch capable of remaining in an activated state by continuous pressure thereon by the vehicle operator.

14. The vehicle safety feature of claim 12, wherein said master switch is a flip-flop switch capable of remaining in an activated state until deactivation by a vehicle operator.

15. The vehicle safety feature of claim 12, wherein said master switch is a time delay switch capable of remaining activated over a preset time period.

16. The vehicle safety feature of claim 12, wherein said master switch is a combination switch providing for at least two of instantaneous activation, flip-flop activation, and time-delay activation by selected manipulation of said switch by the vehicle operator.

17. The vehicle safety feature of claim 16 wherein said combination switch is a three-position switch having a default inactivated off position for normal driving, a flip-flop or time delay on position for activating said combination switch for inactivating noise making accessories for a time determined by the driver, or a preset time sufficient to cross railroad tracks to safety, respectively, and an instantaneous position for activating at least one of a loop tape player, cabin warning lights, and a brief audible signal.

18. The vehicle feature of claim 3, wherein said master switch further comprises remote control means for selective activation, said remote control means comprising a hand-held remote control element and a receiver responsive to Rf signals from said remote controller and capable of activation or inactivation of said master switch.

19. The safety feature of claim 3, wherein said master switch is at least one of color coded or uniquely shaped.

20. The safety feature of claim 3, wherein said master switch comprises means for lighting said master switch, indicating at least one of an inactivated state, an activated state, and a differentiated inactivated and activated state.
